(19) United States
(12) Patent Application Publication
(10) Pub. No.: US 2017/0342655 A1
(43) Pub. Date: Nov. 30, 2017

(54) PROCESS FOR COATING BOTH SIDES OF A WEB IN ONE PASS

(71) Applicant: Milliken & Company, Spartanburg, SC (US)

(72) Inventors: Ramesh Keshavaraj, Peachtree City, GA (US); Michael D. Hurst, LaGrange, GA (US)

(21) Appl. No.: 15/164,308

(22) Filed: May 25, 2016

(51) Int. Cl. D06M 23/00; D06M 15/564; D06M 15/643; B60R 21/235

(52) U.S. Cl. CPC D06M 23/005; D06M 15/643; D06M 15/564; B60R 2021/23533

(57) ABSTRACT

A process for coating a fabric web on upper and lower sides in one pass containing unwinding a fabric web, coating the upper side of the fabric web with a upper coating composition using a first coater, coating the lower side of the fabric web with a lower coating composition using a second coater, drying the coated fabric web in a horizontal dryer, and winding up the coated fabric web.

The upper and lower coatings are each in an add-on amount of between about 10 and 75 GSM. The second coater comprises an entry edge and a beveled exit edge, where the entry edge is located closer to the first coater than the beveled exit edge, the entry edge of the second coater is in contact with the lower side of the fabric web, and the beveled exit edge of the second coater is not in contact with the web.

The invention provides a process for coating both sides of a web in one pass.

### BACKGROUND

Coatings for second impact or rollover side curtain applications demand higher level of performance compared to frontal airbags in that these curtains are required to hold gas for more than 5 seconds in a rollover event. High coat weights of polymers are typically used in such applications where the total coating weights range from 75 to 125 GSM.

There remains a need to improve the application process of when it is desired to coat both sides of the fabric separately. There have been attempts to coat both sides in one shot but that warrants vertical ovens such that the bottom coated side does not comes in contact with any parts of the processing equipment before curing/drying.

This invention not only eliminates the expense of the vertical oven and building/tower infrastructure expenses but doubles the throughput of the coating equipment.

### BRIEF SUMMARY OF THE INVENTION

A process for coating a fabric web on upper and lower sides in one pass containing unwinding a fabric web having an upper side and a lower side, coating the upper side of the fabric web with a upper coating composition using a first coater forming an upper coating, coating the lower side of the fabric web with a lower coating composition using a second coater forming a lower coating, drying the coated fabric web in a horizontal dryer, and winding the coated fabric web onto a windup roller.

The upper and lower coatings are each in an add-on amount of between about 10 and 75 GSM. The second coater comprises an entry edge and a beveled exit edge, where the second coater is oriented such that the entry edge is located closer to the first coater than the beveled exit edge, the entry edge of the second coater is in contact with the lower side of the fabric web, and the beveled exit edge of the second coater is not in contact with the fabric web forming a gap between the beveled exit edge of the second coater and the lower side of the fabric web.

### BRIEF DESCRIPTION OF THE FIGURES

An embodiment of the present invention will now be described by way of example, with reference to the accompanying drawings.

FIG. 1 is side-view illustration of the coating machine.

FIG. 2 is an enlarged side-view illustration of the first and second coaters.

### DETAILED DESCRIPTION OF THE INVENTION

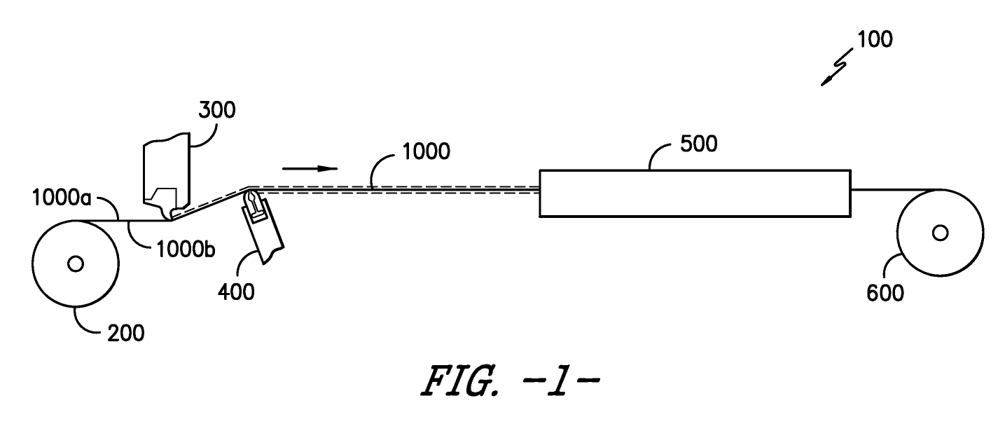

Referring now to FIG. 1, there is shown a coating machine 100 of a fabric web 1000. The fabric web 1000 may can be any suitable textile substrate having an upper side 1000a and a lower side 1000b. Preferably, the fabric web is a textile suitable for use in airbags. Preferably, the fabric web is a woven textile. Such woven textiles comprise a plurality of yarns interlaced in a suitable weave pattern, such as a plain weave, twill weave or a satin weave. In another embodiment, the fabric web is a woven textile constructed in a plain weave. The woven textile can be constructed from any suitable yarn or combination of yarns. Preferably, the fabric web is a woven textile comprising a plurality of synthetic yarns. The synthetic yarns can comprise any suitable synthetic fibers. Preferably, the synthetic yarns comprise fibers selected from the group consisting of polyamide fibers (e.g., nylon 6 fibers, nylon 6, 6 fibers), polyester fibers (e.g., polyethylene terephthalate fibers, polytrimethylene terephthalate fibers, polybutylene terephthalate fibers), polyolefin fibers, and mixtures thereof. In a more preferred embodiment, the synthetic yarns comprise fibers selected from the group consisting of polyamide fibers, polyester (PET) fibers, polyolefin fibers, polytrimethylene terephthalate (PTT), and mixtures thereof.

The yarns used in making the fabric web can have any suitable linear density. Preferably, the yarns have a linear density of about 100 dtex or more or about 110 dtex or more. Preferably, the yarns have a linear density of about 1,500 dtex or less, or about 700 dtex or less. The yarns used in making the fabric web preferably are multifilament yarns, which means each yarns comprises a plurality of filaments or fibers, such as those mentioned above. In such multifilament yarns, the filaments or fibers preferably have linear densities of about 7 dtex or less, or about 5 dtex or less (e.g., about 4.5 dtex or less).

The fabric web 1000 is unwound from an unwinder 200. The unwinder 200 serves store the yet uncoated fabric web and delivers the fabric web 1000 into the other parts of the coating machine 100.

The fabric web 1000 travels to the first coater 300 which coats an upper coating 1100 onto the fabric web 1000. The upper coating 1100 is coated in a wet or uncured state. The first coater 300 may be any suitable coater that is able to deliver the desired upper coating composition at the desired add-on rate. The first coater may be, for example, a gravure coater, a reverse roll coater, a knife over roll coater (also known as gap coaters), a metering rod coater (also known as a Meyer rod coater), a curtain coater, and an air over knife coater.

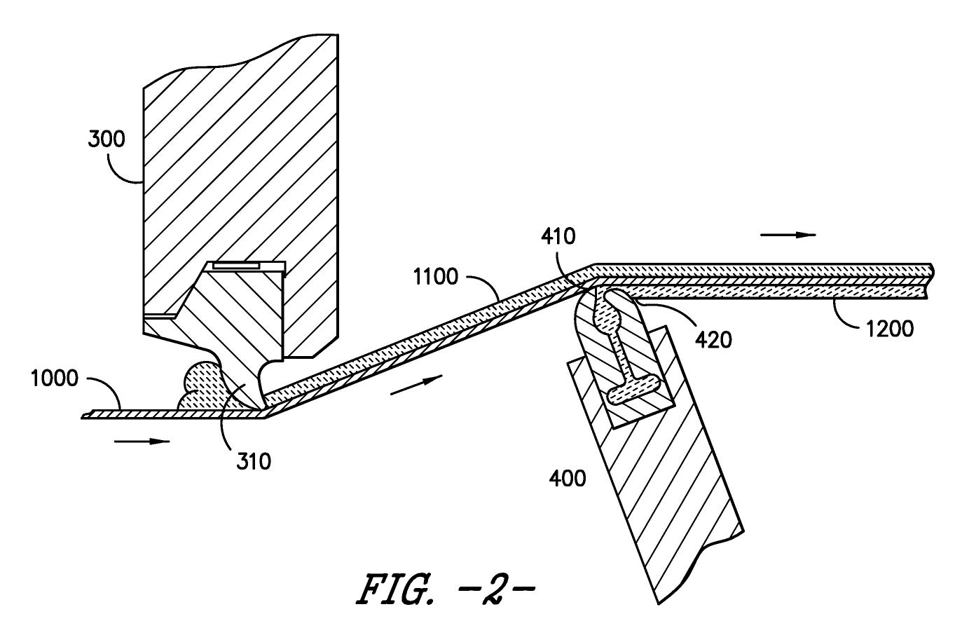

Preferably, the first coater is an air over knife coater. A preferred embodiment where the second coater 300 is an air over knife coater can be shown in more detail in FIG. 2. FIG. 2 shows the knife section 310 of the air over knife coater 300. An air over knife coater has been shown to be able to coat airbag type coatings at the desired add-on ranges efficiently and equally across the fabric web.

Preferably, the add-on amount of the upper coating is between about 10 and 75 GSM (grams per square meter). In a more preferred embodiment, the add-on amount of the upper coating is between about 50 and 60 GSM. In a more preferred embodiment, the add-on amount of the upper coating is between about 50 and 40 GSM. In a more preferred embodiment, the add-on amount of the upper coating is between about 40 and 30 GSM. In a more preferred embodiment, the add-on amount of the upper coating is between about 30 and 20 GSM. This add-on amount stated is the total amount of coating added and thus includes any water or other solvents used in the coating process.

After the fabric web 1000 pass by the first coater 300 and receives the upper coating 1100 and while the upper coating 1100 is still in its wet or cured state, the lower coating 1200 is applied to the fabric web 1000 by the second coater 400. Referring to FIG. 2, there is shown an enlargement of the coating machine 100 so that more detail on the first coater 300 and the second coater 400 can be seen. Preferably, the add-on amount of the lower coating is between about 10 and 75 GSM. In a more preferred embodiment, the add-on amount of the lower coating is between about 50 and 60 GSM.

Preferably, there is no fabric web drying/curing apparatus between the first coater 300 and the second coater 400 (other than ambient air). In one embodiment, the first coater 300 and the second coater 400 are within 4 feet of each other, more preferably within 2 feet of each other, more preferably within 1 foot of each other, more preferably between about 6 inches of each other. In one embodiment, the coaters are between about 1 inch and 3 feet from each other, in another embodiment, the coaters are preferably between about 1 inch and 20 feet from each other. While the coaters are preferably close to one another, they are two separate and distinct coaters. They are not different parts or areas of the same coater (such as different parts of an immersion bath).

It is not a simple process to coat the underside of a fabric web at relatively high add-on weights (about 10 to 75 GSM). It is known to coat the underside of film webs with coatings for release or other purposes but typically they are in the grams per thousand square meters range (a 1000 x reduction in the coating thickness than the described process) and therefore use different processes and have different coating issues than a thick coating such as on the fabric web of the invention.

The second coater 400 comprises an entry edge 410 and a beveled exit edge 420. The second coater 400 is oriented such that the entry edge 410 is located closer to the first coater 300 than the beveled exit edge 420. The entry edge 410 of the second coater 400 is in contact with the lower side 1000b of the fabric web 1000. The beveled exit edge 420 of the second coater 400 forming a gap with the fabric web 1000 (shown as G on the Fig) between the beveled exit edge 420 of the second coater 400 and the lower side 1000b of the fabric web 1000. Not shown in the Fig is that inside the coater, the coating is pressurized through a conduit that has a precise location across the width for coating fluid jets to disperse in order to apply the coating on to the fabric web at a precise rate.

The bottom applicator contains a slot which in turn contains the fluid conduit to supply the coating fluid under pressure. The knife is of a unique design where the entry end has only the function of creating tension on the fabric that is already coated on the top. In doing so, the knife deflects the fabric such that there is gap between the beveled exit side of the blade and the fabric. The gap created by the beveled side of the blade determines along with the quantity of the fluid being pumped, the precise add-on on the bottom side. The add-on on the bottom side has other variables beside the blade geometry and delivered quantity, namely the speed of the moving fabric that has the effect on the shearing characteristics of the coating fluid.

The add-on rate of the lower coating 1200 to the fabric web 1000 is controlled my many different process and machine parameters. The add-on amount of the lower coating 1200 at least partially is controlled by the gap G between the beveled exit edge 420 of the second coater 400 and the lower side 1000b of the fabric web 1000. Keeping the other parameters constant, the larger the gap, the higher the add-on weight. The add-on amount of the lower coating 1200 at least partially is controlled by the pressure within the second coater. Keeping the other parameters constant, the higher the pressure, the higher the add-on weight. The add-on amount of the lower coating 1200 at least partially is controlled by the viscosity of the lower coating composition. Keeping the other parameters constant, the lower the viscosity, the higher add-on weight (though when the viscosity reaches a lower limit, it makes it more difficult to coat the lower coating composition onto the underside, of the fabric web). The add-on amount of the lower coating 1200 at least partially is controlled by the speed of the fabric web 1000. Keeping the other parameters constant, the higher the speed of the fabric web 1000, the lower the add-on weight. The lower coating is being delivered is under pressure and the add-on is controlled is through application rate, fabric web speed, and gap.

The upper coating composition may be any suitable coating and may be solvent based (aqueous or non-aqueous) or an uncured coating. In one embodiment, the upper coating composition comprises a thermoplastic polymer. In one embodiment, the upper coating composition comprises a thermoplastic polymer selected from the group consisting of polyurethane, polyacrylate, acrylic co-polymer, polyurethane-polyacrylate hybrid, acrylic, vinyl acetate, vinyl chloride, vinyl alcohol, urethane, styrene butadiene, acrylonitrile, ethylene vinyl acetate, and ethylene vinyl chloride, vinylidene chloride, polyvinyl chloride, polyvinyl butyral, silicone, and hybrid resins thereof. In another embodiment, the second thermoplastic polymer is selected from the group consisting of acrylic, vinyl acetate, vinyl chloride, vinyl alcohol, urethane, styrene butadiene, acrylonitrile, ethylene vinyl acetate, and ethylene vinyl chloride, vinylidene chloride, and is preferably an acrylic latex such as TR77, HAS. HA16, TR934, TR407 (Rohm and Haas) or 21638 (Hycar), HYCAR 561X87 or HYCAR 26804 (B.F. Goodrich), Paranol AC 793, Paranol AC 774. In one embodiment, the upper coating composition comprises polyurethane. It has been found that polyurethane has good coating and air-blocking properties useful for airbag applications.

In one embodiment, the upper coating composition comprises a water based dispersion comprising water and a thermoplastic. Preferably, the upper coating composition comprises a water based polyurethane dispersion. Preferably, the water based polyurethane dispersion comprises between about 40 and 65% by weight water. The rheology of the dispersion is a critical parameter in controlling the desired add-on level on the bottom side.

In one embodiment, the upper coating composition is applied to the fabric web 1000 as a foam. In cases where more add-on is desired lowering the density is specifically helpful when the coating is foamed especially in case of the lower coater. If desired the foam can be completely collapsed in the curing or drying process.

In another embodiment, the upper coating composition comprises a thermoset. In one embodiment, the upper coating composition comprises silicone. Commercially-available silicones suitable for use in producing such coatings include, but are not limited to, the silicone sold under the product designation “X-32” by Shin-Etsu Chemical Co., Ltd. of Japan and the silicone sold under the product designation “6291” by Wacker Chemie.

As can be envisioned by those skilled in the art, if a second layer coating is deemed necessary on top of the dried or cured first layer on each side of the web in some engineering applications, the addition of a second double sided coater for the application of a second layer on top and the bottom side would not deviate from the teachings of this invention.

The coating details (including the coating composition, processes, and add-on weights) for the lower coating composition may be selected from the embodiments discussed in relation to the upper coating composition. The lower coating composition is coated onto the lower side 1000b of the fabric web 1000 forming the lower coating 1200. In one embodiment, the coating composition of the first coating composition and the second composition are the same. In one embodiment, the two coaters, the first coater 300 and the second coater 400 may be feed from the same batch of coating composition. In one embodiment, the add-on weight of the upper coating 1100 is approximately the same as the add-on weight of the lower coating 1200. In one embodiment, the add-on weight of the upper coating 1100 is within 10% by weight of the add-on weight of the lower coating 1200. Having approximately the same add-on weight in the upper and lower coatings is preferable for even drying/curing in the horizontal oven 500.

In another embodiment, the upper coating 1100 has different characteristics than the lower coating 1200. This may include, for example, having different coating compositions or different add-on rates. Preferably, both the upper and lower coatings both comprise thermoplastic polymers or thermoset polymers.

After the fabric web 1000 is coated on the lower side 1000b of the fabric web, the fabric web 1000 is transported into a horizontal dryer 500. The horizontal dryer 500 serves to cure and/or dry the coatings, both the upper coating 1100 and the lower coating 1200 at the same time. It is important for the fabric web 1000 not to be in contact with any rollers after being coated. Preferably, the fabric web 1000 is held along the edges of the fabric web 1000 (referred to as the selvedge edges) in tension so that nothing comes in contact with either the upper or lower sides of the textile web 1000. The fabric web is preferably held by pins or clips along its selvedge edges.

The temperature, amount of air flow, and length of the horizontal dryer is determined by the thickness of the coatings 1100, 1200, by the materials in the first coating composition and the second coating composition, and by the speed of the fabric web.

After the upper and lower coatings are dry and/or cured, the coated fabric web 1000 is wound up on a windup roller 600 (there may be additional steps, machines, and/or processes between the horizontal dryer 500 and the windup roller 600). After being wound up on the windup roller 600, the coated fabric web 1000 may be transported to another machine for additional processes (such as cutting, printing, etc) or may be sold in roll form.

The coated fabric web may be used for any suitable purpose or end use. On preferred use is for the coated fabric web to be used as an airbag fabric. The airbag may be used for any suitable purpose. In one embodiment, the airbag is part of an airbag module, where the airbag enclosing an interior volume and the module also contains a gas generator being connected to the airbag and a cover at least partially enclosing the airbag and gas generator. This airbag and/or airbag module may be used in any suitable device such as a vehicle like a sedan, truck, or SUV. For example, the airbag can comprise at least two discrete textile substrates that are sewn, stitched, or otherwise bonded together in such a way as to enclose an interior volume that can be inflated. Alternatively, the airbag can be a one-piece woven airbag, which essentially comprises a textile substrate having two layer areas (double layer regions) and single layer areas (single layer regions) where the two layers are woven together to enclose an interior volume that can be inflated. Such one-piece woven airbags and suitable constructions for the same are described, for example, in U.S. Pat. Nos. 7,543,609; 7,409,970; 7,069,961; 6,595,244; and 6,220,309.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A process for coating a fabric web on upper and lower sides in one pass comprising:
unwinding a fabric web having an upper side and a lower side;
coating the upper side of the fabric web with a upper coating composition using a first coater forming an upper coating, wherein the upper coating is in an add-on amount of between about 10 and 75 gsm, and wherein the upper coating is coated in a wet or uncured state;
coating the lower side of the fabric web with a lower coating composition using a second coater forming a lower coating, wherein during the coating of the lower side of the fabric web the upper coating on the upper side is in the wet or uncured state, wherein the lower coating is coated in a wet or uncured state, and wherein the lower coating is in an add-on amount of between about 10 and 75 gsm;
wherein the second coater comprises an entry edge and a beveled exit edge, wherein the second coater is oriented such that the entry edge is located closer to the first coater than the beveled exit edge, wherein the entry edge of the second coater is in contact with the lower side of the fabric web, wherein the beveled exit edge is utilized to control the add-on of the second coater on the lower side of the fabric web;
drying the coated fabric web in a horizontal dryer, wherein drying the fabric web comprises drying or curing the upper coating and drying or curing the lower coating; and,
winding the coated fabric web onto a windup roller.

2. The process of claim 1, wherein the upper coating composition comprises a water based polyurethane dispersion.

3. The process of claim 1, wherein the water based polyurethane dispersion is foamed.

4. The process of claim 2, wherein the water based polyurethane dispersion comprises between about 40 and 65% by weight water.

5. The process of claim 1, wherein the upper coating is in an add-on amount of between about 30 and 40 gsm.

6. The process of claim 1, wherein the lower coating composition comprises a water based polyurethane dispersion.

7. The process of claim 1, wherein the lower coating is in an add-on amount of between about 30 and 40 gsm.

8. The process of claim 1, wherein the upper coating composition and the lower coating composition have the same composition.

9. The process of claim 1, wherein the upper coating composition comprises a silicone.

10. The process of claim 1, wherein the lower coating composition comprises a silicone.

11. The process of claim 1, wherein the fabric web is a woven fabric.

12. The process of claim 1, wherein the fabric web is an airbag fabric.

13. The process of claim 1, wherein the fabric web is a non-woven fabric.

14. The process of claim 1, wherein the fabric web is a one-piece woven airbag fabric, wherein the one-piece woven airbag fabric comprises single layer regions and double layer regions.

15. The process of claim 1, wherein the fabric web is held by pins or clips as it passes through the horizontal dryer.

16. The process of claim 1, wherein the first coater is a knife over air coater.

17. The process of claim 1, wherein the add-on amount of the lower coating by the second coater is controlled at least in part by the viscosity of the lower coating composition.

18. The process of claim 1, wherein the add-on amount of the lower coating by the second coater is controlled at least in part by the speed of the fabric web.

19. The process of claim 15, wherein the add-on amount of lower coating is controlled at least in part by the width of the gap.

20. The process of claim 1, wherein the add-on amount of coating by the second coater is controlled at least in part by the pressure in the second coater.

21. The process of claim 1, wherein the second coater is located within 12 inches of the first coater.

22. The process of claim 1, wherein the second coater is located within 6 inches of the first coater.

23. The process of claim 1, wherein there is not a fabric web dryer between the first coater and the second coater.

24. A process for coating an airbag fabric web on upper and lower sides in one pass comprising:
unwinding a web having an upper side and a lower side;
coating the upper side of the web with a upper coating composition using a first coater forming an upper coating, wherein the upper coating is in an add-on amount of between about 10 and 75 gsm, and wherein the upper coating is coated in a wet or uncured state;
coating the lower side of the web with a lower coating composition using a second coater forming a lower coating, wherein during the coating of the lower side of the web the upper coating on the upper side is in the wet or uncured state, wherein the lower coating is coated in a wet or uncured state, and wherein the lower coating is in an add-on amount of between about 10 and 75 gsm;
drying the coated web, wherein drying the web comprises drying or curing the upper coating and drying or curing the lower coating; and,
winding the coated web onto a windup roller.
